(19) United States
(12) Patent Application Publication
(10) Pub. No.: US 2025/0363320 A1
(43) Pub. Date: Nov. 27, 2025

(54) LABEL PRINTER EXECUTING PRINTING BASED ON LABEL DATA AND PRINTING SYSTEM INCLUDING INFORMATION PROCESSING DEVICE, LABEL PRINTER AND SERVER

(71) Applicant: BROTHER KOGYO KABUSHIKI KAISHA, Nagoya (JP)

(72) Inventor: Ryo TERAFUJI, Nagoya (JP)

(21) Appl. No.: 19/209,190

(22) Filed: May 15, 2025

(30) Foreign Application Priority Data
May 27, 2024 (JP) 2024-085600

(51) Int. Cl. G06K 15/02; G06F 40/109; G06F 40/166; G06K 15/00

(52) U.S. Cl. CPC G06K 15/1836; G06F 40/109; G06F 40/166; G06K 15/4015

(57) ABSTRACT

A label printer includes: a printing engine; a memory; and a controller. The controller is configured to perform, when receiving a first print instruction, a first printing process including: generating first print data by rasterizing target label data using font data stored in the memory; and executing printing based on the first print data with the printing engine. The controller is configured to perform, when receiving a second print instruction: a transmission requesting process including: transmitting, to a server, a transmission request specifying the target label data; and in response to receiving second print data from the server as a response to the transmission request, a second printing process including: executing printing based on the second print data with the printing engine. The second print data is generated by the server rasterizing label data stored in the server and corresponding to the target label data specified in the transmission request.

### REFERENCE TO RELATED APPLICATIONS

This application claims priority from Japanese Patent Application No. 2024-085600 filed on May 27, 2024. The entire content of the priority application is incorporated herein by reference.

### BACKGROUND ART

A known system configuration includes a printer, and an external device other than the printer. The external device is used for converting data to be printed to data supported by the printer. For example, the printer obtains a document file from a web server and determines whether the file format of the obtained file is supported by the printer. If not supported, the printer issues a request to a server capable of converting the document file to data that the printer supports. The printer requests the server to convert the document file and to return the converted file. In response to this request, the printer receives the converted data transmitted from the server and executes printing based on the received data.

### SUMMARY

Label printers can execute printing based on label data created on personal computers (PCs) or other external devices. However, while an external device can use a wide variety of fonts for creating label data, the label printer has a limited number of supported fonts. One conceivable configuration for a label printer faced with executing printing based on label data containing unsupported fonts is to transfer the label data to a server and request rasterization, as in the known technology described above. However, technologies for executing printing based on label data created by external devices have room for improvement.

In order to attain the above and other objects, according to one aspect, the present disclosure provides a label printer. The label printer includes: a printing engine; a communication interface; a user interface; a memory; and a controller. The controller is configured to perform: in response to receiving label data from an information processing device via the communication interface, a storage process; a label selection process; and an instruction receiving process. The storage process includes: storing. The storing included in the storage process stores the label data received from the information processing device in the memory. The label data is transmitted from the information processing device to the label printer and a server. The memory is configured to store therein one or more sets of label data including the label data received from the information processing device. The server is configured to store therein one or more sets of label data including the label data received from the information processing device. The label selection process includes: receiving. The receiving included in the label selection process receives, via the user interface, a selection of one of label data as target label data. The one set of label data is selected from among the one or more sets of label data stored in the memory. The instruction receiving process includes: receiving. The receiving included in the instruction receiving process receives, via the user interface, a print instruction in a state where the target label data stored in the memory is selected. The print instruction is one of a first print instruction and a second instruction. The controller is configured to further perform: when the receiving included in the instruction receiving process receives, as the print instruction, the first print instruction: a first printing process; and when the receiving included in the instruction receiving process receives, as the print instruction, the second print instruction: a transmission requesting process; and a second printing process. The first printing process includes: generating; and executing. The generating included in the first printing process generates first print data by rasterizing the target label data using font data stored in the memory. The executing included in the first printing process executes printing based on the first print data with the printing engine. The transmission requesting process includes: transmitting. The transmitting included in the transmission requesting process transmits, to the server, a transmission request specifying the target label data via the communication interface. The second printing process is performed in response to receiving second print data from the server via the communication interface as a response to the transmission request. The second print data has been generated by the server rasterizing label data corresponding to the target label data specified in the transmission request. The label data corresponding to the target label data is one set of label data among the one or more sets of label data stored in the server. The second printing process includes executing. The executing included in the second printing process executes printing based on the second print data with the printing engine.

The label printer described in the present specification receives label data created by an application program of an information processing device and stores the label data in the memory of the label printer itself. The label data is also stored in the server in advance. When receiving a first print instruction, the label printer generates first print data by rasterizing the label data stored in the memory of the label printer using font data stored in the memory of the label printer and executes printing based on the first print data. Thus, the label printer can execute printing based on the label data even when the label printer is offline. When receiving a second print instruction, on the other hand, the label printer receives second data generated by the server rasterizing label data stored in the server and executes printing based on the second data. Thus, even when fonts not supported by the label printer are set in the label data created by the application program of the information processing device, when the server stores font data corresponding to those fonts therein, the label printer can print text rendered in those fonts.

According to another aspect, the present disclosure also provides a label printer. The label printer includes: a printing engine; a communication interface; a user interface; a memory; and a controller. The controller is configured to perform: in response to receiving label data from an information processing device via the communication interface, a storage process; a label selection process; and an instruction receiving process. The storage process includes: storing. The storing included in the storage process stores the label data received from the information processing device in the memory. The label data is transmitted from the information processing device to the label printer and a server. The memory is configured to store therein one or more sets of label data including the label data received from the information processing device. The server is configured to store therein one or more sets of label data including the label data received from the information processing device. The label selection process includes: receiving. The receiving included in the label selection process receives, via the user interface, a selection of one set of label data as target label data. The one set of label data is selected from among the one or more sets of label data stored in the memory. The instruction receiving process includes: receiving. The receiving included in the instruction receiving process receives, via the user interface, a print instruction in a state where the target label data stored in the memory is selected. The controller is configured to further perform, in response to receiving the print instruction: when communication between the label printer and the server is possible: a transmission requesting process; and an online process; and when the communication between the label printer and the server is not possible: an offline printing process. The transmission requesting process includes: transmitting. The transmitting included in the transmission requesting process transmits, to the server, a transmission request specifying the target label data via the communication interface. The online printing process is performed in response to receiving print data from the server via the communication interface as a response to the transmission request. The received print data has been generated by the server rasterizing label data corresponding to the target label data specified in the transmission request. The label data corresponding to the target label data is one set of label data among the one or more sets of label data stored in the server. The online printing process includes: executing. The executing included in the online printing process executes printing based on the received print data with the printing engine. The offline printing process includes: generating; and executing. The generating included in the offline printing process generates print data by rasterizing the target label data using font data stored in the memory. The executing included in the offline printing process executes printing based on the generated print data with the printing engine.

According to still another aspect, the present disclosure further provides a printing system. The printing system includes: an information processing device; a label printer; and a server. A set of computer-readable instructions is installed in the information processing device. The set of computer-readable instructions, when executed, causes the information processing device to perform: a creation process; and a transmission process. The creation process includes: creating. The creating included in the creation process creates label data. The transmission process includes: transmitting. The transmitting included in the transmission process transmits the label data created in the creation process to the label printer and the server. The server is configured to perform: in response to receiving the label data from the information processing device, a server storage process. The server storage process includes: storing. The storing included in the server storage process stores the label data received from the information processing device in a memory of the server. The memory of the server is configured to store therein one or more sets of label data including the label data received from the information processing device. The label printer is configured to perform: in response to receiving the label data from the information processing device, a printer storage process; a label selection process; an instruction receiving process; a first printing process; and a transmission requesting process. The printer storage process includes: storing. The storing included in the printer storage process stores the label data received from the information processing device in a memory of the label printer. The memory of the label printer is configured to store therein one or more sets of label data including the label data received from the information processing device. The label selection process includes: receiving. The receiving included in the label selection process receives, via a user interface of the label printer, a selection of one set of label data as target label data. The one set of label data is selected from among the one or more sets of label data stored in the memory of the label printer. The instruction receiving process includes: receiving. The receiving included in the instruction receiving process receives, via the user interface of the label printer, a print instruction in a state where the target label data stored in the memory of the label printer is selected. The print instruction is one of a first print instruction and a second print instruction. The first printing process is performed when the receiving included in the instruction receiving process receives, as the print instruction, the first print instruction. The first printing process includes: generating; and executing. The generating included in the first printing process generates first print data by rasterizing the target label data using font data stored in the memory of the label printer. The executing included in the first printing process executes printing based on the first print data with a printing engine of the label printer. The transmission requesting process is performed when the receiving included in the instruction receiving process receives, as the print instruction, the second print instruction. The transmission requesting process includes: transmitting. The transmitting included in the transmission requesting process transmits, to the server, a transmission request specifying the target label data. The server is configured to further perform: in response to receiving the transmission request from the label printer, a data transmission process. The data transmission process includes: generating; and transmitting. The generating included in the data transmission process generates second print data by rasterizing label data corresponding to the target label data specified in the transmission request. The label data corresponding to the target label data is one set of label data among the one or more sets of label data stored in the memory of the server. The transmitting included in the data transmission process transmits the second print data to the label printer. The label printer is configured to further perform: in response to receiving the second print data from the server as a response to the transmission request, a second printing process. The second printing process includes: executing. The executing included in the second printing process executes printing based on the second print data with the printing engine of the label printer.

A control method, a set of computer-readable instructions, and a computer-readable storage medium storing the set of computer-readable instructions for implementing the functions of the above devices are also novel and useful.

The technology disclosed in this specification enables a label printer to suitably execute printing based on label data created by an external device.

### BRIEF DESCRIPTION OF DRAWINGS

FIG. 1 is a block diagram illustrating the configuration of a printing system and an electrical structure of a label printer included in the printing system.

FIG. 2 is a diagram illustrating a manner of storing label data in the label printer.

FIG. 3 is an external perspective view of the label printer.

FIG. 4 is a schematic diagram illustrating an internal configuration of the label printer.

FIG. 5 is a sequence diagram illustrating steps in a preparation procedure performed in the printing system.

FIG. 6 is a sequence diagram illustrating steps in a device-side procedure performed in the printing system.

FIG. 7 is a sequence diagram illustrating steps in an online process performed in the printing system.

FIG. 8 is a flowchart illustrating steps in an offline process performed on the label printer.

### DESCRIPTION

Next, an embodiment of a label printer according to the present disclosure will be described in detail while referring to the accompanying drawings. The present embodiment describes a printing system including the label printer of the present disclosure, a cloud server, and a personal computer (hereinafter abbreviated as “PC”).

### Overall Configuration of Printing System

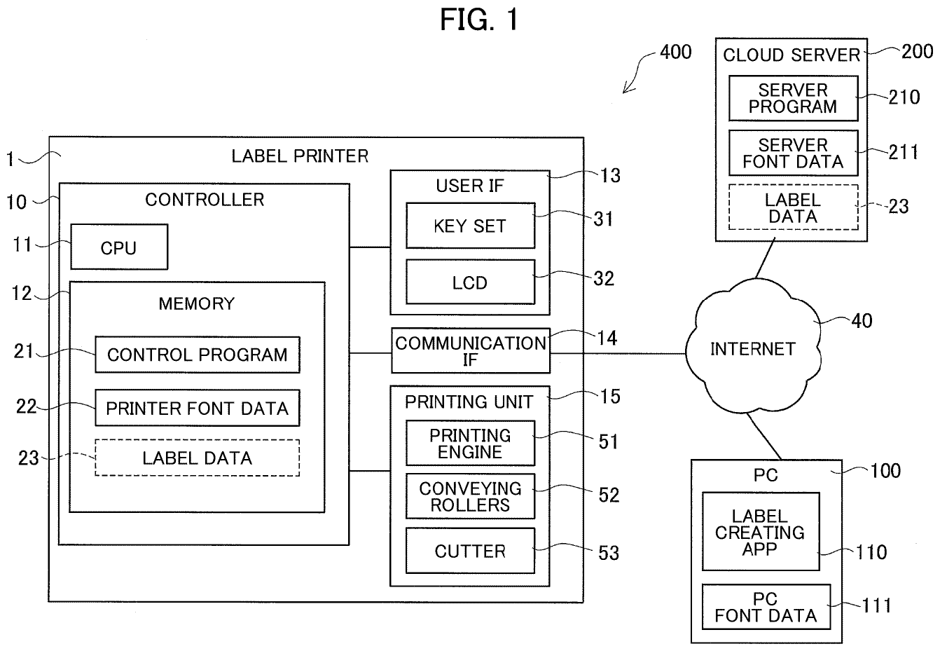

FIG. 1 illustrates a printing system 400 according to the present embodiment. The printing system 400 includes a label printer 1, a PC 100, and a cloud server 200. The label printer 1, PC 100, and cloud server 200 are connected to an internet 40 and can communicate with each other. Note that the printing system 400 may include a plurality of label printers and a plurality of PCs and is not limited to one each.

The label printer 1 of the present embodiment includes a controller 10 that includes a CPU 11 and a memory 12. The label printer 1 further includes a user interface (also referred to as “user IF”) 13, a communication interface (also referred to as “communication IF”) 14, and a printing unit 15, each of which is electrically connected to the controller 10.

The CPU 11 executes various processes according to programs read from the memory 12 or based on user operations. Note that the controller 10 in FIG. 1 is a general concept that covers all hardware and software used for controlling the label printer 1 and is not limited to representing a single piece of hardware actually present in the label printer 1.

The memory 12 in the label printer 1 of the present embodiment stores various programs, including a control program 21, and various data. The control program 21 is a program that instructs the label printer 1 to perform operations for printing and to input and output various data. The control program 21 includes a program that functions as an operating system. Examples of data stored in the memory 12 may include font data (hereinafter, font data that the label printer 1 possesses will be called “printer font data”) 22, and label data 23 to be printed.

The label printer 1 stores printer font data 22 for one or a plurality of printer fonts and can support fonts (printer fonts) based on the printer font data 22 stored in the memory 12. Specifically, the printer font data 22 includes a set of font data corresponding to a standard font. In addition to the standard font, the label printer 1 can also support one or a plurality of optional fonts, and stores one set of or a plurality of sets of font data for one or a plurality of optional fonts as the printer font data 22. The optional fonts can be added to or removed from the printer fonts, and the corresponding font data is accordingly added to or deleted from the printer font data 22 stored in the memory 12. The set of font data corresponding to the standard font will be referred to as standard font data.

The label data 23 is in a format that can be used for printing on the label printer 1. The label data 23 is created by a label creating application program (hereinafter referred to as “label creating app”) 110 described later. The label data 23 will be described later in detail. The memory 12 is used as a work area when various processes are executed. A buffer provided in the CPU 11 is also one example of memory.

Other examples of memory include, for example, ROM, RAM, or a hard disk drive built into the label printer 1 or any storage medium that is readable and writable by the CPU 11. A USB memory connected to the label printer 1, an external memory such as a hard disk drive, and a memory or hard disk drive provided in a device connected to the label printer 1 via the communication interface 14 are all examples of memory.

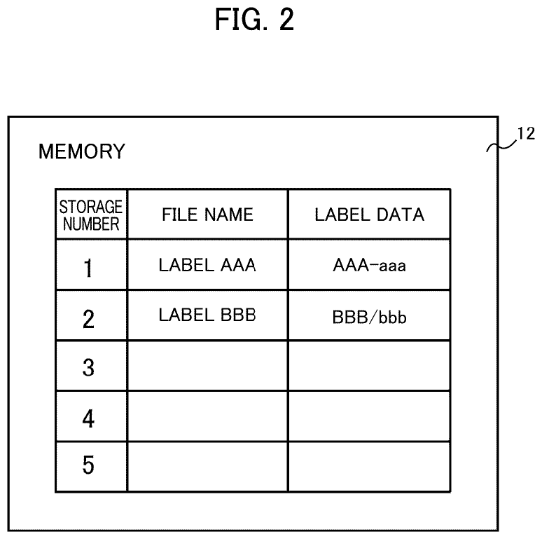

Memory areas for saving a plurality of sets of label data 23 are allocated in the memory 12 of the label printer 1, enabling the label printer 1 to store a plurality of sets of label data 23 in the memory 12. In the present embodiment, five memory areas for saving label data 23 have been allocated in the memory 12 of the label printer 1, as illustrated in FIG. 2. Each memory area is assigned a storage number. The label printer 1 stores label data 23 and a file name of the label data 23 in association with the storage number of the memory area. No label data 23 is stored in the memory 12 when the label printer 1 is shipped from the factory. Further, the number of sets of label data 23 that can be stored in the memory 12 is not limited to five but may be four or less, or six or more.

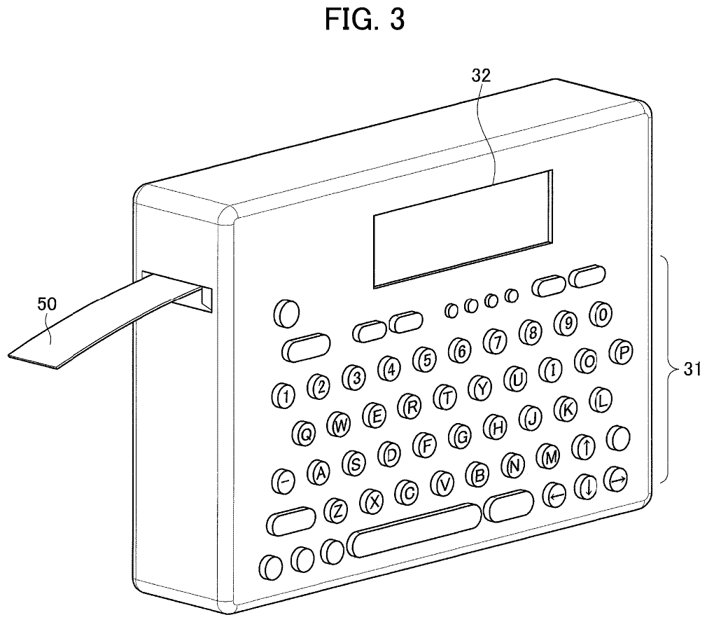

The user interface 13 includes hardware that displays screens for notifying the user of information, and hardware that receives user operations. Specifically, the user interface 13 of the present embodiment has a key set 31 including a plurality of keys, and a liquid crystal display (also referred to as “LCD”) 32, as illustrated in FIG. 3. The user interface 13 may also include a touchscreen having both a notifying function and an operation-receiving function. Alternatively, the user interface 13 may include separate notifying means, such as indicator lamps.

The communication interface 14 includes hardware for communicating with external devices. The communication standard employed by the communication interface 14 may be Ethernet (registered trademark), Wi-Fi (registered trademark), or Universal Serial Bus (USB). “Ethernet” is a Japanese trademark of FUJIFILM Business Innovation Corp. “Wi-Fi” is a registered trademark of Wi-Fi Alliance. The label printer 1 may also include a plurality of communication interfaces 14 compatible with a plurality of communication standards. As illustrated in FIG. 1, the label printer 1 can connect to the internet 40 via the communication interface 14 and can communicate with various devices connected to the internet 40, such as the PC 100 and cloud server 200.

The printing unit 15 includes configurations for printing images on an elongated printing medium for use as labels. Since the label printer 1 performs printing on a continuous tape-shaped printing medium having a prescribed width and conveying the printing medium, the printing unit 15 includes a printing engine 51 for printing, various conveying rollers 52 for conveying the printing medium, and a cutter 53 for cutting the printed printing medium. In the present embodiment, the printing medium is referred to as “tape,” and the dimension of the tape in the widthwise direction is referred to as the “tape width.” Furthermore, the direction in which the tape travels when conveyed in the label printer 1 is referred to as the “longitudinal direction.” The tape includes a backing paper, which is a tape-shaped base material, and a plurality of labels, which are stickers, arranged in succession along the longitudinal direction and affixed to the backing paper. The label printer 1 performs printing on the labels while feeding the tape from a roll loaded in the label printer 1 and cuts the tape to separate the printed labels from the remainder of the tape.

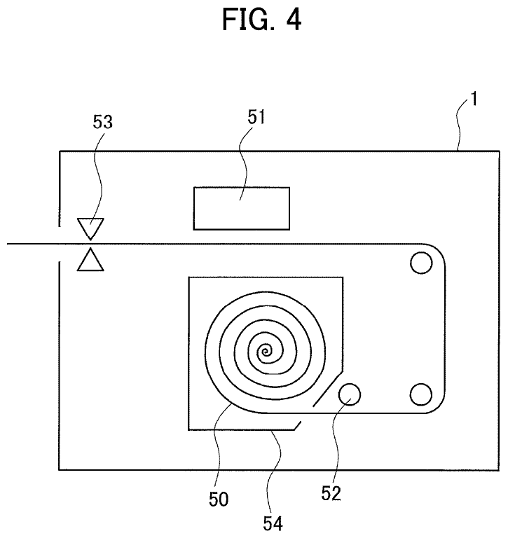

Specifically, a cassette 54 may be detachably mounted in the label printer 1, as depicted in the example of FIG. 4. The cassette 54 holds tape 50 wound in a roll. While the cassette 54 is mounted in the label printer 1, the label printer 1 performs parallel operations to feed out the tape 50 with the conveying rollers 52 and to execute printing on the tape 50 with the printing engine 51. The printing engine 51 may be of a thermal type or a thermal transfer type. The label printer 1 supports a plurality of types of tape widths and determines the printing range according to the tape 50 that is loaded. The printable range of the label printer 1 in the width direction is determined for each tape width according to the mechanical configuration of the printing engine 51. The printing engine 51 is an example of the printing engine of the present disclosure.

The label printer 1 feeds the tape 50 out while performing printing on the tape 50. The printed portion of the tape 50 is ejected out of the device through a discharge opening (see FIG. 3). The cutter 53 of the label printer 1 is positioned near the inner side of the discharge opening (see FIG. 4). The cutter 53 cuts off the label protruding outside the label printer 1 from the remainder of the tape 50. The cutter 53 may also be mounted on the outside of the discharge opening as an optional unit.

The PC 100 can communicate with the label printer 1 and the cloud server 200 and can execute various processes. While not illustrated in FIG. 1, the PC 100 includes a CPU, a memory, a user interface, and a communication interface similar to the label printer 1. The PC 100 may be a desktop computer or a mobile computer.

The PC 100 stores a label creating app 110 having functions for creating label data, and font data (hereinafter, font data that the PC 100 possesses will be referred to as “PC font data”) 111. The PC 100 also stores one or a plurality of sets of PC font data 111 and can support fonts based on (corresponding to) the PC font data 111. The fonts supported by the PC 100 may be the same as or different from the fonts supported by the label printer 1. Generally, the PC 100 has a greater memory capacity than the label printer 1 and would normally store more font data than the label printer 1. In other words, the PC 100 is likely to support more fonts than the label printer 1.

The cloud server 200 can communicate with the label printer 1 and the PC 100 and can execute various processes. While not illustrated in FIG. 1, the cloud server 200 also has a CPU, a memory, a user interface, and a communication interface similar to the label printer 1 and the PC 100.

The cloud server 200 stores a server program 210 having functions for generating print data by rasterizing label data, and font data (hereinafter, font data that the cloud server 200 possesses will be referred to as “server font data”) 211. The cloud server 200 also stores one or a plurality of sets of server font data 211 and can support fonts based on (corresponding to) the server font data 211. The fonts supported by the cloud server 200 may be the same as or different from the fonts supported by the label printer 1 and the fonts supported by the PC 100. In general, the cloud server 200 has a greater memory capacity than the label printer 1 and PC 100 and normally stores more font data than the label printer 1 and PC 100. That is, the cloud server 200 is likely to support more fonts than the label printer 1 and PC 100.

The cloud server 200 can also store one or a plurality of sets of the label data 23 created by the label creating app 110. The label data 23 is stored in the cloud server 200 in association with various information.

### Printing Procedures in the Printing System

Next, printing procedures performed in the printing system 400 of the present embodiment will be described. The printing procedures performed in the printing system 400 of the present embodiment include a preparation procedure executed in response to user operations on the PC 100, and a device-side procedure executed in response to the user operating the label printer 1.

### Preparation Procedure

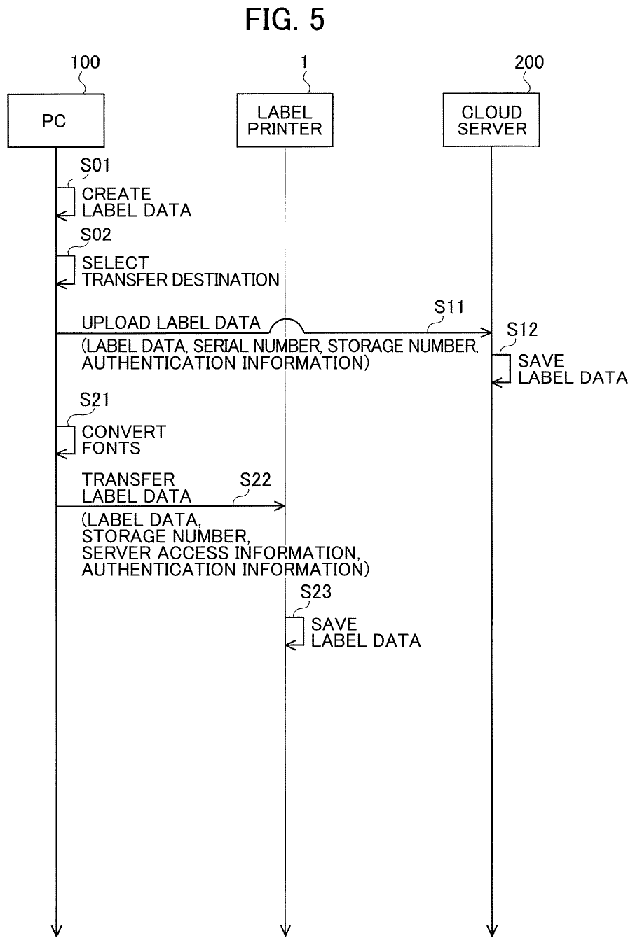

FIG. 5 is a sequence diagram illustrating steps in the preparation procedure performed in the printing system 400. In the preparation procedure, processes performed on the PC 100 are executed by the CPU of the PC 100; processes performed on the label printer 1 are executed by the CPU 11 of the label printer 1; and processes performed on the cloud server 200 are executed by the CPU of the cloud server 200.

First, in S01 of the preparation procedure the PC 100 creates label data 23. Specifically, the PC 100 starts up the label creating app 110 and, through the label creating app 110, receives user operations to edit the label data 23 to be printed. The label creating app 110 can use the PC font data 111, and when creating the label data 23, the label creating app 110 sets fonts supported by the PC 100 for the label data 23. In other words, fonts supported by the PC 100 are used in the label data 23 created by the label creating app 110.

In S02 the PC 100 selects a transfer destination for the label data 23 created in S01. Label printers constituting candidates for the transfer destination are registered on the PC 100 in advance, and the PC 100 receives a selection from among the registered label printers to be the transfer destination. During the process of registering a label printer, the PC 100 communicates with the label printer being registered; obtains information related to the label printer being registered, such as the printer name, address information, serial number, and specification information; and records the obtained information. When a label printer 1 is selected as the transfer destination, the PC 100 further prompts the selected label printer 1 to identify available storage numbers, i.e., storage numbers corresponding to memory areas in which no label data is currently stored, and receives a selection of one of the available storage numbers as the storage destination. The PC 100 can receive a transfer instruction once a transfer destination has been selected.

When a transfer instruction is received, in S11 the PC 100 uploads the label data 23 created in S01 to the cloud server 200. In addition to the label data 23, the PC 100 transmits the serial number of the label printer 1 selected as the transfer destination, the selected storage number, corresponding file name, and authentication information in association with the label data 23. The authentication information is used for authentication, which is required when using the label data 23. The authentication information may be generated automatically by the label creating app 110 or inputted by the user. The authentication information uploaded to the cloud server 20 in S11 is an example of the first authentication information of the present disclosure.

Upon receiving the label data 23, in S12 the cloud server 200 saves the received label data 23 and the information associated with the label data 23. Hence, the label data 23 created in S01 is stored in the cloud server 200 in association with the serial number, storage number, file name of the label data 23, and authentication information for the label printer selected in S02.

After receiving a transfer instruction, in S21 the PC 100 also converts fonts set in the created label data 23 to fonts supported by the label printer 1 selected as the transfer destination. The PC 100 may obtain information on fonts supported by the selected label printer 1 when obtaining available storage numbers from the selected label printer 1 in S02, or the information on fonts supported by the selected label printer 1 may be obtained and saved in advance when the label printer 1 is registered on the PC 100. Note that when the fonts set in the label data 23 created in S01 are supported by the label printer 1 selected as the transfer destination, the PC 100 may skip S21 and may treat the label data 23 created in S01 as the label data 23 converted in S21. When any of the fonts set in the label data 23 created in S01 is not supported by the label printer 1 selected as the transfer destination, the PC 100 converts the label data 23 by changing the unsupported font to the standard font using the standard font data included in the printer font data 22.

In S22 the PC 100 transfers the converted label data 23 to the label printer 1 selected as the transfer destination. In addition to the converted label data 23, the PC 100 transmits the selected storage number, server access information for accessing the cloud server 200, and the authentication information in association with the label data 23. The URL or IP address of the cloud server 200 are examples of the server access information. The server access information may also include account information when the account information is used to access the cloud server 200. Alternatively, the label printer 1 selected as the transfer destination may already possess the server access information for accessing the cloud server 200, in which case transferring such server access information is unnecessary. The authentication information transmitted to the label printer 1 is the same as the authentication information transferred to the cloud server 200.

After receiving the converted label data 23 via the communication interface 14, in S23 the label printer 1 as the transfer destination saves the received label data 23 and the information associated with the label data 23. That is, the label data 23 converted in S21 is stored in the memory area corresponding to the selected storage number, and the server access information and authentication information are stored in the label printer 1 in association with the storage number. The process of S23 is an example of the storage process of the present disclosure.

The PC 100 may execute either one of the process of uploading the label data 23 to the cloud server 200 and the process of transferring the label data 23 to the label printer 1 first or may perform both simultaneously.

Through this preparation procedure, label data 23 created on the PC 100 by the label creating app 110 is saved in both the cloud server 200 and the label printer 1. Specifically, on one hand, the label data 23 created by the label creating app 110 is saved in the cloud server 200 as is. On the other hand, the label data 23 saved in the label printer 1 is not the unaltered label data 23 created by the label creating app 110 but is the converted label data 23 in which fonts have been changed to fonts supported by the label printer 1.

Note that the label printer 1 may convert the label data 23 instead of the PC 100. In other words, the PC 100 may transmit the label data 23 created by the label creating app 110 to the label printer 1 as is, and the label printer 1 may convert any unsupported fonts set in the received label data 23 to fonts that the label printer 1 supports. Specifically, the label printer 1 may convert any unsupported fonts set in the received label data 23 to the standard font using the standard font data included in the printer font data 22. Having the label printer 1 convert unsupported fonts to supported fonts increases the possibility of fonts being converted to suitable ones. On the other hand, when the PC 100 converts fonts in the label data 23 to fonts supported by the label printer 1 prior to transferring the label data 23, as described in FIG. 5, there is no need for the label printer 1 to perform such font conversions, thereby reducing the processing load on the label printer 1.

### Device-Side Procedure

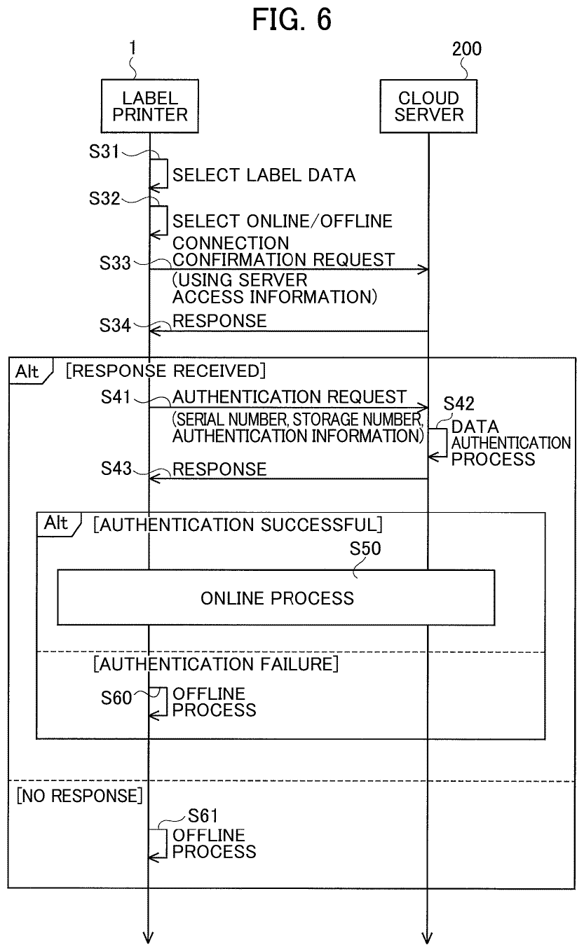

FIG. 6 is a sequence diagram illustrating steps in a device-side procedure performed in the printing system 400. In the device-side procedure, processes performed on the label printer 1 are executed by the CPU 11 of the label printer 1, and processes performed on the cloud server 200 are executed by the CPU of the cloud server 200.

In S31 of the device-side procedure, the label printer 1 first selects label data to be printed. Specifically, the label printer 1 receives a user selection via the user interface 13 for label data to be printed from among the plurality of sets of label data 23 stored in the memory 12, and selects the label data corresponding to the received user selection. The process of S31 is an example of the label selection process of the present disclosure. The label data to be printed and selected in S31 is an example of the target label data of the present disclosure.

In S32 the label printer 1 selects whether editing of label data is to be performed online or offline. Specifically, the label printer 1 receives a user selection via the user interface 13 indicating whether to edit the label data online or offline. The process of S32 is an example of the usage selection process of the present disclosure. When “offline” has been selected in S32, the label printer 1 does not communicate with the cloud server 200 but performs editing and printing of label data as an offline process of S61 using the label data 23 stored in the memory 12. The offline process will be described later in greater detail.

When “online” has been selected in S32, the label printer 1 performs editing and printing of label data using the label data 23 saved in the cloud server 200. In S33 the label printer 1 uses the server access information associated with the selected label data to transmit a connection confirmation request to the cloud server 200 via the communication interface 14. Upon receiving the connection confirmation request, in S34 the cloud server 200 returns a response to the received connection confirmation request.

Here, the label printer 1 may transmit a login request to the cloud server 200 as the connection confirmation request and may receive the result of the login process from the cloud server 200 as a response to the login request. In this case, information used to log in to the cloud server 200 may be stored on the label printer 1 in advance, or the label printer 1 may receive the information used to log in to the cloud server 200 from the PC 100 as the server access information.

When the label printer 1 receives a response from the cloud server 200 to the connection confirmation request (Alt: RESPONSE RECEIVED), in S41 the label printer 1 transmits an authentication request specifying the selected label data to the cloud server 200 via the communication interface 14. The authentication request is associated with the serial number of the label printer 1 itself, the storage number associated with the selected label data, and the authentication information associated with the selected label data. The process of S41 is an example of the authentication requesting process of the present disclosure. The authentication information transmitted to the cloud server 200 in S41 is an example of the second authentication information of the present disclosure.

Upon receiving the authentication request, in S42 the cloud server 200 uses the various information associated with the authentication request to perform a data authentication process for the specified label data. For example, the cloud server 200 determines whether label data 23 corresponding to the serial number and storage number received from the label printer 1 is saved in the cloud server 200 itself. The cloud server 200 responds with “authentication failed” when the corresponding label data 23 is not saved in the cloud server 200. When the corresponding label data 23 is saved in the cloud server 200, on the other hand, the cloud server 200 further determines whether the authentication information associated with the saved label data 23 matches the authentication information received from the label printer 1. In S43 the cloud server 200 responds to the label printer 1 with “authentication successful” when the authentication information matches and with “authentication failed” when the information does not match. Responses for an authentication failure may be differentiated for cases in which the label data is not saved on the cloud server 200 and cases in which the authentication information does not match, or the response may be the same in both cases.

By using the serial number and storage number to check on the existence of label data corresponding to the label data selected on the label printer 1, the cloud server 200 can avoid needless operations on the label printer 1 when that label data is not stored in the cloud server 200. In addition to the serial number and storage number, the filename of the label data may be used to confirm the existence of the label data on the cloud server 200.

Even when the cloud server 200 stores therein label data corresponding to the label data selected on the label printer 1, the potential for non-corresponding label data being edited can be reduced by further using the authentication information to determine whether the label data corresponds to the label data selected on the label printer 1, i.e., whether both sets of label data have been transmitted simultaneously from the label creating app 110 in the preparation procedure.

When an “authentication successful” response has been received from the cloud server 200 (Alt: AUTHENTICATION SUCCESSFUL), in S50 the label printer 1 executes an online process in conjunction with the cloud server 200 using the label data stored in the cloud server 200 that corresponds to the selected label data.

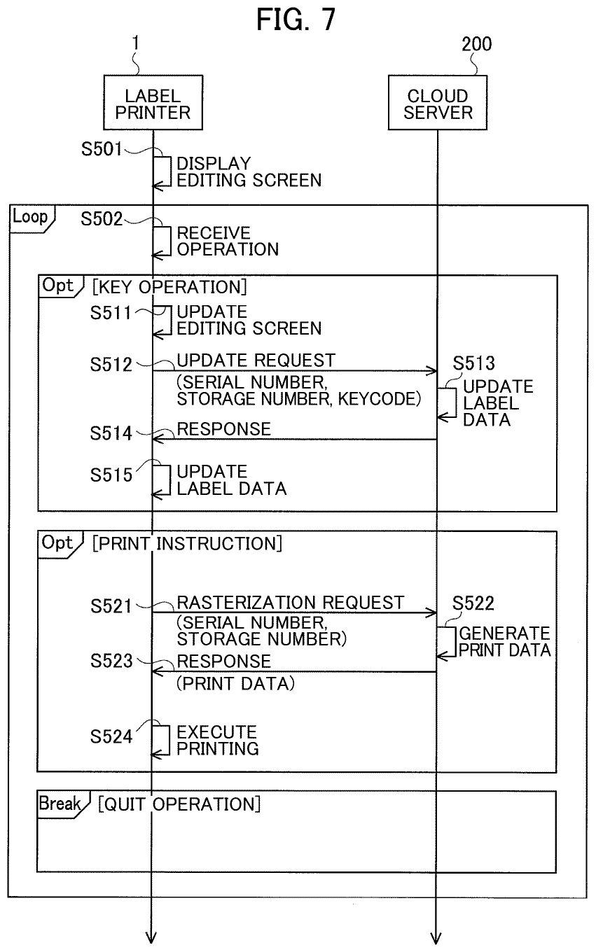

FIG. 7 is a sequence diagram illustrating steps in the online process of S50. In S501 at the beginning of the online process, the label printer 1 displays an editing screen on the liquid crystal display 32 for editing the selected label data. The label printer 1 displays text contained in the selected label data on the liquid crystal display 32 using the printer font data 22. Specifically, the label printer 1 displays a text image corresponding to each text object contained in the selected label data on the liquid crystal display 32 using the printer font data 22. When any of the fonts used for the text does not correspond to any of the printer font data 22 supported by the label printer 1, the label printer 1 displays the text using the standard font data included in the printer font data 22. The process of S501 is an example of the displaying process of the present disclosure. While the editing screen is displayed, in S502 the label printer 1 receives various user operations via the key set 31.

Some examples of operations that can be received in S502 are key operations for editing text contained in the label data 23, a print instruction, and a quit operation for ending the online process. The print instruction received in the online process is an example of the second print instruction of the present disclosure. The process to receive the print instruction in S502 is an example of the instruction receiving process of the present disclosure. The process to receive key operations for editing text in S502 is an example of the edit receiving process of the present disclosure.

For example, each time the label printer 1 receives a key operation for editing text (Opt: KEY OPERATION), in S511 the label printer 1 updates the text (text image) displayed on the editing screen based on the received key operation. The label printer 1 also uses the printer font data 22 when updating text (text image) displayed on the editing screen. The process of S511 is an example of the first updating process of the present disclosure.

Moreover, each time a key operation for editing text is received, in S512 the label printer 1 transmits an update request specifying the selected label data to the cloud server 200 via the communication interface 14. The update request is associated with the serial number of the label printer 1 itself, the storage number corresponding to the selected label data, and the key code corresponding to the received key operation. The key code is information specifying the operated key from among the plurality of keys contained in the key set 1. The process of S512 is an example of the second updating process of the present disclosure.

Upon receiving an update request, in S513 the cloud server 200 reads the label data corresponding to the serial number and storage number received from the label printer 1 from among the label data 23 saved in the cloud server 200 and updates the text (text object) contained in the read label data in accordance with the received key code. The fonts set in label data 23 saved in the cloud server 200 are configured of fonts supported by the PC 100 and are not updated even when the text (text object) is updated. After updating the text (text object), in S514 the cloud server 200 transmits a response to the update request to the label printer 1.

When the label printer 1 receives a response to the update request from the cloud server 200 via the communication interface 14, in S515 the label printer 1 updates the text (text object) contained in the selected label data 23 stored in the memory 12 in accordance with the received key operation. Thus, both the label data 23 stored in the label printer 1 and the label data 23 stored in the cloud server 200 are updated in response to a single key operation on the label printer 1.

When a print instruction is received (Opt: PRINT INSTRUCTION), in S521 the label printer 1 transmits a rasterization request specifying the selected label data to the cloud server 200 via the communication interface 14. The rasterization request is associated with the serial number of the label printer 1 itself and the storage number corresponding to the selected label data. The process of S521 is an example of the transmission requesting process of the present disclosure.

Upon receiving a rasterization request, in S522 the cloud server 200 reads the label data corresponding to the serial number and storage number received from the label printer 1 from among the label data 23 saved in the cloud server 200 and generate rasterized print data based on the read label data using the server font data 211. The print data generated in S522 is an example of the second print data of the present disclosure and the generated print data of the present disclosure. The server font data 211 possessed by the cloud server 200 is used for performing rasterization on the cloud server 200. Since the cloud server 200 can likely use fonts supported by the PC 100, there is a high probability that the cloud server 200 can generate print data rendered in fonts supported by the PC 100 when such fonts are set in the label data. After generating the print data, in S53 the cloud server 200 transmits the print data generated in S522 to the label printer 1 as a response to the rasterization request.

When the label printer 1 receives print data via the communication interface 14 as a response from the cloud server 200 to the rasterization request, in S524 the label printer 1 uses the printing engine 51 to execute printing based on the received print data. Thus, the label printer 1 can be expected to print images containing text rendered in fonts supported by the PC 100. The process of S524 is an example of the second printing process of the present disclosure and the online printing process of the present disclosure.

When a quit operation is received during the online process (Opt: QUIT OPERATION), the label printer 1 ends the online process. In the event of a quit operation, the label printer 1 may instruct the cloud server 200 to log out, for example.

Returning to the description of FIG. 6, when an “authentication failed” response has been received from the cloud server 200 (Alt: AUTHENTICATION FAILURE), or when a timeout has occurred without receiving an “authentication successful” response from the cloud server 200, in S60 the label printer 1 executes an offline process using the label data 23 saved in the memory 12 and without communicating with the cloud server 200.

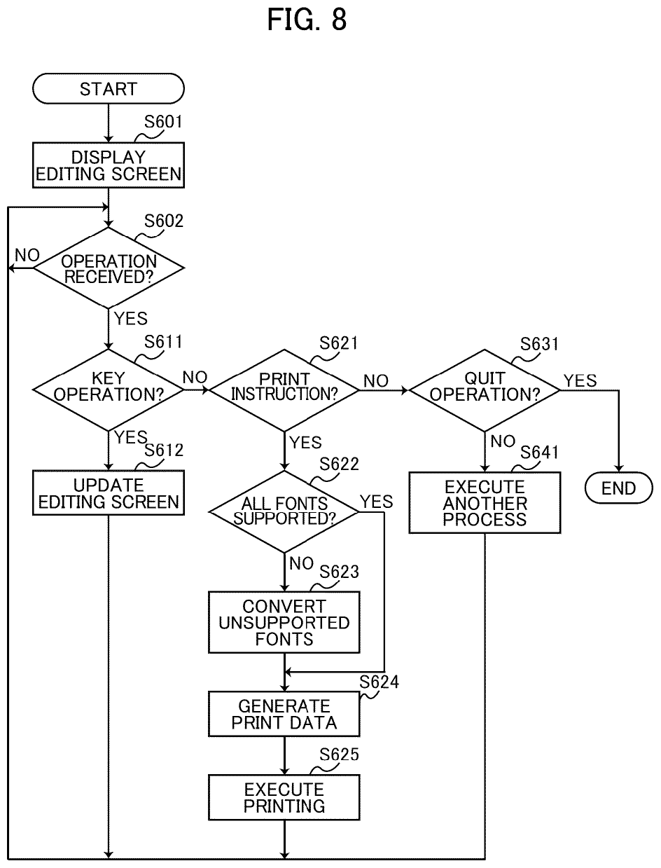

FIG. 8 is a flowchart illustrating steps in the offline process of S60. In S601 at the beginning of the offline process, the label printer 1 displays an editing screen on the liquid crystal display 32 for editing the selected label data. The label printer 1 uses the printer font data 22 to display text contained in the selected label data on the liquid crystal display 32. When any of fonts used for the text does not correspond to any set of the printer font data 22, the label printer 1 displays the text (text image) using the standard font data included in the printer font data 22. In S602 the label printer 1 receives various user operations via the key set 31 while the editing screen is displayed.

As in S502 of the online process, examples of operations that the label printer 1 can receive in S602 are key operations for editing text contained in the label data 23, a print instruction, and a quit operation for ending the offline process. The print instruction received in S62 is an example of the first print instruction of the present disclosure. The process to receive a print instruction in S602 is an example of the instruction receiving process of the present disclosure. The label printer 1 continues to wait while no operation has been received (S602: NO) and advances to S611 when an operation is received (S602: YES).

When the operation received in S602 is a key operation for editing text (S611: YES), in S612 the label printer 1 updates the text (text image) displayed on the editing screen based on the received key operation. As in S601, the label printer 1 also uses the printer font data 22 when updating the text (text image) displayed on the editing screen.

Although text (a text image) is updated on the editing screen when a key operation is received in the offline process, the label data 23 stored in the memory 12 is not updated. That is, if the label data 23 saved in the label printer 1 were updated in the offline process, the content of text in this label data 23 would no longer match the label data 23 saved on the cloud server 200. Therefore, when key operations are received, the label printer 1 temporarily preserves the updated text content and uses the temporarily preserved text for displaying the editing screen and printing, but the label printer 1 does not update the label data 23 stored in the memory 12.

When the operation received in S602 is not a key operation (S611: NO) but rather a print instruction (S621: YES), in S622 the label printer 1 determines whether the fonts set in the selected label data 23 are supported. When unsupported fonts are set in the selected label data 23 (S622: NO), in S623 the label printer 1 uses the printer font data 22 to convert each of the unsupported fonts set in the selected label data 23 to a font that the label printer 1 supports. Specifically, the label printer 1 converts the unsupported fonts set in the selected label data to the standard font using the standard font data included in the printer font data 22.

After converting the fonts in S623 or when all fonts set in the selected label data 23 are supported (S622: YES), in S624 the label printer 1 rasterizes the selected label data 23 using the printer font data 22 to generate print data. The print data generated in S624 is an example of the first print data of the present disclosure and the generated print data of the present disclosure. In S625 the label printer 1 uses the printing engine 51 to execute printing based on the generated print data. Through this process, the label printer 1 can print images depicting text in fonts supported by the PC 100. The process of S624 and S625 is an example of the first printing process of the present disclosure and the offline printing process of the present disclosure.

When the operation received in S602 is not a key operation (S611: NO) and not a print instruction (S621: NO) but is a quit operation (S631: YES), the label printer 1 ends the offline process. Furthermore, when the received operation is not a quit operation (S631: NO), in S641 the label printer 1 executes another process corresponding to the received instruction.

When the response from the cloud server 200 is “authentication failed,” the label printer 1 is unable to obtain print data rasterized by the cloud server 200. Therefore, the label printer 1 executes the offline process, using the printer font data 22 to rasterize the label data 23 stored in the memory 12 and executing printing based on the print data generated through this rasterization. This process can avoid situations in which the label printer 1 is unable to execute printing based on the selected label data.

Note that when the response from the cloud server 200 is “authentication failed,” the label printer 1 may first prompt the user via the user interface 13 to confirm whether to continue the process prior to executing the offline process of S60. In this case, when a selection to continue the process is received, the label printer 1 executes the offline process of S60. However, when a selection to end the process is received, the label printer 1 does not execute the offline process of S60 but ends the device-side procedure.

Since the label printer 1 cannot execute printing based on print data rasterized by the cloud server 200 when executing printing in the offline process, text might be printed in different fonts from the fonts set by the label creating app 110 of the PC 100. Hence, when printing is executed in the offline process following an authentication failure, the label printer 1 may notify the user via the user interface 13 that printing has been performed offline or that printing has been performed using fonts supported by the label printer 1.

Returning to the description in FIG. 6, when the label printer 1 receives no response from the cloud server 200 to the connection confirmation request transmitted in S33 (Alt: NO RESPONSE), in S61 the label printer 1 executes an offline process similar to when the response from the cloud server 200 is “authentication failed.” The offline process of S61 is the same as the offline process of S60. Alternatively, the label printer 1 may prompt the user via the user interface 13 to confirm whether to continue the process and may execute the offline process of S61 when a selection to continue the process is received. When printing is executed through an offline process that has been initiated due to no response from the cloud server 200, the label printer 1 may notify the user via the user interface 13 that printing has been executed offline or that printing has been performed using fonts that the label printer 1 supports, in the same way as when an “authentication failed” response has been received from the cloud server 200.

The label printer 1 cannot receive print data rasterized by the cloud server 200 when the label printer 1 is unable to communicate with the cloud server 200, i.e., when the communication between the label printer 1 and the cloud server 200 is not possible. Accordingly, the label printer 1 executes the offline process to perform printing using the printer font data 22, thereby avoiding a situation in which the label printer 1 is unable to execute printing based on the specified label data.

Furthermore, when the user selects “offline” in S32, the label printer 1 executes the offline process just as when an “authentication failed” response is received from the cloud server 200. Thus, the label printer 1 can execute printing based on the specified label data even when the environment has originally been set to offline.

As described above, the label creating app 110 of the PC 100 transmits the label data 23 to both the cloud server 200 and the label printer 1. When the label printer 1 receives a print instruction in a state where “offline” is selected, the label printer 1 rasterizes the label data 23 stored in the memory 12 of the label printer 1 using the printer font data 22 stored in the memory 12 of the label printer 1 itself to generate print data and executes printing based on the generated print data. Thus, the label printer 1 can execute printing based on the label data 23 even when the label printer 1 is offline. When the label printer 1 receives a print instruction in a state where the “online” is selected, on the other hand, the cloud server 200 rasterizes the label data 23 stored in the cloud server 200 using the server font data 211 stored in the cloud server 200 to generate print data. The label printer 1 executes printing after receiving the generated print data from the cloud server 200. In this way, even when fonts not supported by the label printer 1 are set in the label data 23 created by the label creating app 110 of the PC 100, i.e., even when the label data 23 created by the label creating app 110 of the PC 100 contains text (a text object) that uses fonts not supported by the label printer 1, the label printer 1 can print text in those fonts when the cloud server 200 has server font data 211 corresponding to the fonts.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The device possessing the label creating app 110 is not limited to a PC but may be a smartphone, for example.

In the present embodiment, the label printer 1 executes the offline process when a response to the connection confirmation request is not received from the cloud server 200 (Alt: NO RESPONSE). However, the label printer 1 may instead notify the user of the error via the user interface 13 and end the device-side procedure without executing the offline process. Similarly, when the response received from the cloud server 200 is “authentication failed” (Alt: AUTHENTICATION FAILURE), the label printer 1 may notify the user of the error via the user interface 13 and end the device-side procedure without executing the offline process.

In the online process described in the above embodiment, both the label data 23 stored in the label printer 1 and the corresponding label data 23 store in the cloud server 200 are updated each time a key operation is performed on the label printer 1, but the update timing is not limited to this. For example, the label printer 1 may receive an update instruction in addition to key operations. In this case, the label printer 1 updates the image displayed on the editing screen each time a key operation is received and temporarily preserves information indicating all key operations without transmitting an update request to the cloud server 200 until an update instruction is received. When an update instruction is received, the label printer 1 transmits an update request specifying the selected label data to the cloud server 200 in association with the preserved information indicating all key operations to that point, and the cloud server 200 updates the label data 23 saved in the cloud server 200 based on the update request. Alternatively, each time a key operation is received, the label printer 1 may temporally store a corresponding key code in the memory 12, and after a certain number of key codes have been stored in the memory 12, the label printer 1 may transmit the stored key codes, i.e., at least one key code, to the cloud server 200 along with an update request.

In the present embodiment, the label printer 1 issues an authentication request when the user selects “online” and does not issue an authentication request when a key operation or a print instruction is received. However, the label printer 1 may also issue an authentication request when a key operation or a print instruction is received. Additionally, the label printer 1 may be configured not to transmit an update request or a rasterization request when a response indicating an authentication failure is received.

In the above embodiment, the PC 100 transmits the same authentication information to both the label printer 1 and the cloud server 200, but the PC 100 may be configured to transmit authentication information to the cloud server 200 but not the label printer 1. In this case, the label printer 1 prompts the user via the user interface 13 to input authentication information when transmitting an authentication request to the cloud server 200 and associates the inputted authentication information with the authentication request.

When “online” has been selected in the above embodiment, the label printer 1 confirms the connection with the cloud server 200 and issues an authentication request. Thereafter, the label printer 1 executes printing in response to receiving a print instruction. However, the label printer 1 may transmit a rasterization request without confirming the connection or issuing an authentication request.

In the above embodiment, the user is prompted to select either “online” or “offline” after selecting desired label data, but the user need not be required to make the selection. For example, the label printer 1 may periodically confirms the connection with the cloud server 200 and may automatically select to be online when connected to the cloud server 200 and offline when not connected to the cloud server 200. The label printer 1 may also receive a print instruction when label data has been selected, without receiving a selection for online or offline. When a print instruction is received, the label printer 1 first confirms the connection with the cloud server 200. When communication is possible, the label printer 1 executes the online process (S50). When communication is not possible, the label printer 1 executes the offline process (S60). Since label data has been selected in this case, the label printer 1 may issue an authentication request in addition to confirming the connection.

In any of the flow charts and sequence diagrams disclosed in the embodiment, any of the plurality of process steps may be executed in parallel, or the order in which the process steps is performed may be modified in any way that does not produce inconsistencies in the processes.

The processes disclosed in the embodiment may be executed by a single CPU, a plurality of CPUs, an ASIC or other hardware, or a combination of these components. Furthermore, the processes disclosed in the embodiment may be achieved through a storage medium that stores the programs used to implement those processes or according to any of various other methods or formats.

What is claimed is:

1. A label printer comprising:
a printing engine;
a communication interface;
a user interface;
a memory; and
a controller configured to perform:
in response to receiving label data from an information processing device via the communication interface, a storage process including:
storing the label data received from the information processing device in the memory, the label data being transmitted from the information processing device to the label printer and a server, the memory being configured to store therein one or more sets of label data including the label data received from the information processing device, the server being configured to store therein one or more sets of label data including the label data received from the information processing device;
a label selection process including:
receiving, via the user interface, a selection of one set of label data as target label data, the one set of label data being selected from among the one or more sets of label data stored in the memory; and
an instruction receiving process including:
receiving, via the user interface, a print instruction in a state where the target label data stored in the memory is selected, the print instruction being one of a first print instruction and a second print instruction,
wherein the controller is configured to further perform:
when the receiving included in the instruction receiving process receives, as the print instruction, the first print instruction:
a first printing process including:
generating first print data by rasterizing the target label data using font data stored in the memory; and
executing printing based on the first print data with the printing engine; and
when the receiving included in the instruction receiving process receives, as the print instruction, the second print instruction:
a transmission requesting process including:
transmitting, to the server, a transmission request specifying the target label data via the communication interface; and
in response to receiving second print data from the server via the communication interface as a response to the transmission request, a second printing process, the second print data having been generated by the server rasterizing label data corresponding to the target label data specified in the transmission request, the label data corresponding to the target label data being one set of label data among the one or more sets of label data stored in the server, the second printing process including:
executing printing based on the second print data with the printing engine.

2. The label printer according to claim 1,
wherein when communication between the label printer and the server is not possible, the controller performs the first printing process in place of the second printing process.

3. The label printer according to claim 1,
wherein when the label data corresponding to the target label data is not stored in the server, the controller performs the first printing process in place of the second printing process.

4. The label printer according to claim 1,
wherein the controller is configured to further perform:
a usage selection process including:
receiving a selection of whether to use the target label data online or offline,
wherein when the receiving included in the usage selection process receives the selection to use the target label data offline, the receiving included in the instruction receiving process receives, as the print instruction, the first print instruction, and
wherein when the receiving included in the usage selection process receives the selection to use the target label data online, the receiving included in the instruction receiving process receives, as the print instruction, the second print instruction.

5. The label printer according to claim 4,
wherein the controller is configured to further perform, in a state where the target label data stored in the memory is selected:
a displaying process including:
displaying, via the user interface, a text image corresponding to a text object contained in the target label data using the font data stored in the memory, the text object being an object containing one or more characters; and
an edit receiving process including:
receiving, via the user interface, an editing operation for editing the text object contained in the target label data,
wherein the controller is configured to further perform, when the receiving included in the edit receiving process receives the editing operation after the receiving included in the usage selection process receives the selection to use the target label data online:
a first updating process including:
updating, using the font data stored in the memory, the text image displayed via the user interface in accordance with the editing operation; and
a second updating process including:
transmitting, to the server, an update request via the communication interface, the update request specifying the target label data and being associated with at least one key code corresponding to the editing operation, the server being configured to update, in accordance with the at least one key code associated with the update request, the text object in the label data corresponding to the target label data specified in the update request.

6. The label printer according to claim 5,
wherein the transmitting included in the second updating process transmits the update request associated with one key code corresponding to the editing operation, the server being configured to update the text object in accordance with the one key code associated with the update request.

7. The label printer according to claim 5,
wherein the information processing device is configured to transmit, to the label printer and the server, the label data associated with first authentication information,
wherein the controller is configured to further perform:
after the receiving included in the label selection process receives the selection of the target label data associated with second authentication information and stored in the memory and the receiving included in the usage selection process receives the selection to use the target label data online, an authentication requesting process before the receiving included in the edit receiving process is performed, the authentication requesting process including:
transmitting, to the server, an authentication request via the communication interface, the authentication request specifying the target label data and being associated with the second authentication information,
wherein when an authentication success result is received from the server via the communication interface as a response to the authentication request, the controller allows the receiving included in the edit receiving process to receive the editing operation, the authentication success result indicating that the first authentication information associated with the label data corresponding to the target label data specified in the authentication request and stored in the server matches the second authentication information associated with the authentication request, and
wherein when an authentication failure result is received from the server via the communication interface as a response to the authentication request, the controller restricts the receiving included in the edit receiving process from receiving the editing operation, the authentication failure result indicating that the first authentication information associated with the label data corresponding to the target label data specified in the authentication request and stored in the server does not match the second authentication information associated with the authentication request.

8. A label printer comprising:
a printing engine;
a communication interface;
a user interface;
a memory; and
a controller configured to perform:
in response to receiving label data from an information processing device via the communication interface, a storage process including:
storing the label data received from the information processing device in the memory, the label data being transmitted from the information processing device to the label printer and a server, the memory being configured to store therein one or more sets of label data including the label data received from the information processing device, the server being configured to store therein one or more sets of label data including the label data received from the information processing device;
a label selection process including:
receiving, via the user interface, a selection of one set of label data as target label data, the one set of label data being selected from among the one or more sets of label data stored in the memory; and
an instruction receiving process including:
receiving, via the user interface, a print instruction in a state where the target label data stored in the memory is selected,
wherein the controller is configured to further perform, in response to receiving the print instruction:
when communication between the label printer and the server is possible:
a transmission requesting process including:
transmitting, to the server, a transmission request specifying the target label data via the communication interface; and
in response to receiving print data from the server via the communication interface as a response to the transmission request, an online printing process, the received print data having been generated by the server rasterizing label data corresponding to the target label data specified in the transmission request, the label data corresponding to the target label data being one set of label data among the one or more sets of label data stored in the server, the online printing process including:
executing printing based on the received print data with the printing engine; and
when the communication between the label printer and the server is not possible:
an offline printing process including:
generating print data by rasterizing the target label data using font data stored in the memory; and
executing printing based on the generated print data with the printing engine.

9. A printing system comprising:
an information processing device in which a set of computer-readable instructions is installed;
a label printer; and
a server,
wherein the set of computer-readable instructions, when executed, causes the information processing device to perform:
a creation process including;
creating label data; and
a transmission process including:
transmitting the label data created in the creation process to the label printer and the server,
wherein the server is configured to perform:
in response to receiving the label data from the information processing device, a server storage process including:
storing the label data received from the information processing device in a memory of the server, the memory of the server being configured to store therein one or more sets of label data including the label data received from the information processing device,
wherein the label printer is configured to perform:
in response to receiving the label data from the information processing device, a printer storage process including:
storing the label data received from the information processing device in a memory of the label printer, the memory of the label printer being configured to store therein one or more sets of label data including the label data received from the information processing device;
a label selection process including:
receiving, via a user interface of the label printer, a selection of one set of label data as target label data, the one set of label data being selected from among the one or more sets of label data stored in the memory of the label printer;
an instruction receiving process including:
receiving, via the user interface of the label printer, a print instruction in a state where the target label data stored in the memory of the label printer is selected, the print instruction being one of a first print instruction and a second print instruction;
when the receiving included in the instruction receiving process receives, as the print instruction, the first print instruction, a first printing process including:
generating first print data by rasterizing the target label data using font data stored in the memory of the label printer; and
executing printing based on the first print data with a printing engine of the label printer; and
when the receiving included in the instruction receiving process receives, as the print instruction, the second print instruction, a transmission requesting process including:
transmitting, to the server, a transmission request specifying the target label data,
wherein the server is configured to further perform:
in response to receiving the transmission request from the label printer, a data transmission process including:
generating second print data by rasterizing label data corresponding to the target label data specified in the transmission request, the label data corresponding to the target label data being one set of label data among the one or more sets of label data stored in the memory of the server; and
transmitting the second print data to the label printer, and
wherein the label printer is configured to further perform:
in response to receiving the second print data from the server as a response to the transmission request, a second printing process including:
executing printing based on the second print data with the printing engine of the label printer.

10. The printing system according to claim 9,
wherein when an unsupported font that the label printer does not support is set in the label data created in the creation process, the transmitting included in the transmission process converts the label data by changing the unsupported font to a supported font that the label printer supports, and transmits the converted label data to the label printer and the unconverted label data to the server.

11. The printing system according to claim 9,
wherein when an unsupported font that the label printer does not support is set in the target label data, the generating included in the first printing process converts the target label data by changing the unsupported font to a supported font corresponding to the font data stored in the memory of the label printer and generates the first print data by rasterizing the converted target label data.
